(19) United States
(12) Patent Application Publication
(10) Pub. No.: US 2023/0149910 A1
(43) Pub. Date: May 18, 2023

(54) CATALYST COMPOSITION

(71) Applicant: MOMENTIVE PERFORMANCE MATERIALS INC., Waterford, NY (US)

(72) Inventor: Gnuni KARAPETYAN, Cologne (DE)

(21) Appl. No.: 17/907,868

(22) PCT Filed: Mar. 3, 2020
(86) PCT No.: PCT/US2020/020782

§ 371 Date: Aug. 29, 2022

(51) Int. Cl. B01J 31/02; C08G 18/32; C08G 18/08; C08G 18/30; C08G 18/48; C08G 18/22

(52) U.S. Cl. CPC B01J 31/0237; C08G 18/3225; C08G 18/14; C08G 18/302; C08G 18/4829; C08G 18/22; C08G 2101/00

(57) ABSTRACT

The present invention relates to a composition comprising at least one tertiary amino compound (A), and at least one copper(II)-compound (B), a process for the manufacture of said composition, the use of said composition as a catalyst, in particular, as catalyst for the reaction of at least one isocyanate compound with at least one isocyanate-reactive compound, in particular for the manufacture of polyisocyanate polyaddition products, such as polyurethanes, in particular, polyurethane foams.

The present invention relates to a composition comprising at least one tertiary amino compound (A), and at least one copper(II)-compound (B), a process for the manufacture of said composition, the use of said composition as a catalyst, in particular, as catalyst for the reaction of at least one isocyanate compound with at least one isocyanate-reactive compound, in particular for the manufacture of polyisocyanate polyaddition products, such as polyurethanes, in particular, polyurethane foams.

Polyurethane (PU) foams are produced by reacting a di- or polyisocyanate (or prepolymers made thereof) with compounds containing two or more active hydrogens (chain extenders, polyether polyols, polyester polyols, polyether amines and others), generally in the presence of blowing agent (chemical blowing agents as water etc. and physical blowing agents like pentane, cyclopentane, halohydrocarbons etc.), catalysts (tertiary amines, and metalorganic derivatives of tin, bismuth, zinc and others), silicone-based surfactants and other auxiliary agents.

Two major reactions are promoted by the catalysts among the reactants during the preparation of polyurethane foam, gelling and blowing. Development of efficient gelling catalysts exhibiting high catalytic activity beneficially enables a decrease of curing times required for polyurethane foams and hereby advantageously reduce production cycles of final foam articles. Organotin compounds have been often the catalysts of choice promoting gel reaction. Organotin catalysts are being more and more challenged from some environmental and worker exposure standpoint. Consequently, efficient, non-toxic gel catalysts are highly required in PU industry.

US2017/0225158A1 describes the use of copper catalyst composition comprising a copper (II) compound dissolved in a solvent for preparation of mechanically frothed foams and elastomers. WO2012/006263A1 describes the use of copper catalysts for the production of polyurethane elastomers. The catalyst is composed of a copper complex of certain polydentate ligands. The polydentate ligands are generally derivatives of Schiff base and contain at least one nitrogen. The manufacture of such catalysts is elaborate, because first the ligands have to be prepared and thereafter the specific copper complex compounds are to be prepared therefrom. Similarly, e-Polymers 2015; 15(2): 119-126 describes the use of specific copper-amine complexes as a low-emission catalyst for flexible polyurethane foam preparation. WO2002048229A1 describes amine containing carbamates as catalyst in the manufacture of polyurethanes.

Most polyurethane foams emit volatile organic compounds. These emissions can be composed of, for example, contaminations present in raw materials, catalysts, degradation products or unreacted volatile starting materials or other additives. Amine emissions from polyurethane foam have become a major topic of discussion particularly in car interior applications, in furniture or mattresses and the market is therefore increasingly demanding low-emission foams. The automotive industry in particular requires significant reduction of volatile organic compounds (VOC) and condensable compounds (fogging or FOG) in foams.

An evaluation of VOC and FOG profiles of PU foams can be conducted by VDA 278 test. One of the main components of VOC emitting from flexible molded foams is the amine catalyst. To reduce such emissions, catalysts having a very low vapor pressure should be used. Alternatively, if the catalysts have reactive hydroxyl or amine groups they can be linked to the polymer network. If so, insignificant amounts of residual amine catalyst will be detected in the fogging tests. However, the use of reactive amine is not without difficulties. Reactive amines are known to degrade some fatigue properties such as humid aging compression set. Furthermore, the widely used reactive amines are monofunctional and promote chain termination during polymer growth and by becoming covalently bound to the polymer matrix lose their agility as catalysts. Thus, the development of efficient polyurethane catalysts with low emission profile is one of the important targets of modern polyurethane industry.

Two major reactions are promoted by the catalysts among the reactants during the preparation of polyurethane foam, gelling and blowing. Accordingly, the development of efficient gelling catalysts exhibiting high catalytic activity beneficially enables decrease of curing times required for polyurethane foams and hereby advantageously reduce production cycles of final foam articles. Organotin compounds have been often the catalysts of choice promoting gel reaction. Organotin catalysts are being more and more challenged from some environmental and worker exposure standpoint. Consequently, efficient, non-toxic gel catalysts are highly required in PU industry.

Despite the attempts made in the prior art there is still a need for catalyst compositions that are easy to prepare from simple inexpensive components with which polyurethane foams can be prepared which have improved physical properties such as firmness, stiffness or load bearing capacity as reflected in particular by the higher Indentation Load (Force) Deflection or ILD (IFD) which in turn depends on the curing degree of the polyurethane foams which in turn depends on the catalyst performance.

The present inventors surprisingly found that specific catalyst compositions fulfill the aforementioned requirements, and are easy to prepare from inexpensive components, which does not require the intricate manufacture of specific ligands and the manufacture of copper complex compounds therefrom. The catalyst compositions provide an excellent catalyst performance leading to better curing degrees and improved physical properties of polyurethane foams and can be used as efficient catalysts in polyurethane formation with low emission profile.

In accordance with the present invention there are thus provided compositions, comprising (A) at least one tertiary amino compound, and (B) at least one copper(II)-compound, selected from the group consisting of Cu(II)-carboxylates, hydrates and possible adducts with said tertiary amino compound (A) thereof, wherein said compositions comprise unbound tertiary amino compound (A).

Cu(II)-carboxylates (B) include for example Cu(II)-salts with the anions of carboxylic acids. Carboxylic acids and their anionic form “carboxylates” are, in particular, derived from optionally substituted carboxylic acids such as optionally substituted aliphatic, saturated monocarboxylic acids; optionally substituted aliphatic, unsaturated monocarboxylic acids; optionally substituted aliphatic, saturated poly(such as di-)carboxylic acids, optionally substituted heterocyclic carboxylic acids, optionally substituted aromatic carboxylic acids.

Preferably these carboxylic acids include optionally substituted aliphatic saturated carboxylic acids with up to 30 carbon atoms. Optionally substituents include in particular hydroxy, amino (including —NH₂, —NHR and —NR₂ (wherein R is a hydrocarbyl group), halogen, alkoxy (leading to ether function), heterocyclic groups. Among the substituted carboxylic acids, hydroxyfunctional carboxylic acids, such as salicylic acid, lactic acid etc. are most preferred.

Preferred Cu(II)-carboxylates, include copper(II)-salts of carbonic acid, methanoic acid, ethanoic acid, propanoic acid, butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, saturated and unsaturated fatty acids, dicarboxylic acids such as oxalic acid, malonic acid, succinic acid, glutaric acid, adipic acid, pimelic acid, suberic acid, azelaic acid, sebacic acid, undecanedioic acid, dodecanedioic acid, tridecanedioic acid, fumaric acid, maleic acid, hydroxyl-substituted carboxylic acids such as lactic acid (2-hydroxypropanoic acid), 3-hydroxypropanoic acid, malic acid, citric acid, glycolic acid, isocitric acid, mandelic acid, tartronic acid, tartaric acid, aromatic carboxylic acids such as benzoic acid, salicylic acid, phthalic acid, isophthalic acid, terephthalic acid, 2,6-naphthalenedicarboxylic acid, heterocyclic carboxylic acids such as nicotinic acid, pyrrolidine-2-carboxylic acid, amino acids such as glycine, alanine, and aminobutyric acid. Particularly preferred are copper (II) acetate, copper (II) citrate, copper (II) oxalate, copper (II) naphthenate, copper (II) oleate, copper (II)-ethylhexanoate, copper (II)-ricinoleate, copper (II)-stearate, copper (II)-palmitate, copper (II)-laurate, copper (II)-palmitoleate, copper (II)-linoleate, copper (II)-linolenate etc., and the hydrates thereof, e.g. copper (II) citrate hemipentahydrate, and copper (II) acetate monohydrate, and most preferred is copper (II) acetate (Cu(OOCCH₃)₂) and the hydrates thereof, such as in particular Cu(II) acetate monohydrate. The Cu(II)-carboxylates (B) used in accordance with the present invention thus do not include the use of complexed Cu(II)-carboxylates (B) such as Cu(OAc)₂(en)₂ and Cu(OAc)₂(trien)₂ (wherein OAc is acetate, en is ethylenediamine and trien is triethylenetetramine). That is, as described below, the compositions according to the invention are prepared, in particular, by mixing at least one tertiary amino compound (A) and at least one copper(II)-compound (B) selected from the group consisting of Cu(II)-carboxylates (B) or the hydrates thereof.

Possible adducts of said copper(II)-compound (B) with said tertiary amino compound (A) may be formed in the composition in particular by forming coordinate covalent bonding(s), such as N→Cu or O→Cu, and O→Cu together with N→Cu. The compositions according to the invention are however characterised in that they comprise unbound tertiary amino compound (A), that is, these compositions are in particular not exclusively formed of any specific coordination complex compound of copper with the tertiary amino compound (A) of a defined stoichiometry, but they comprise free, that is, unbound, tertiary amino compound (A). The unbound tertiary amino compound (A) accordingly means that free tertiary amino compound that does not bound or does not coordinate in particular to the copper(II) compounds is present in the composition.

Usually the presence of the unbound tertiary amino compound (A) in the compositions of the invention is safeguarded by using an appropriate amount of said tertiary amino compounds (A) in relation to the copper(II) compounds (B).

In a preferred embodiment in the compositions of the invention the weight ratio of the tertiary amine compound (A) to the Cu(II)-compound (B) is >2:1, preferably >4:1, more preferably >9:1, and most preferably >19:1.

An example of an approach of determining an amount of the tertiary amino compound (A) in the compositions of the invention required to have unbound tertiary amino compound (A) in the compositions of the invention is the following. The potential coordination sites at the copper atom and the potentially coordinating atoms at the tertiary amino compound (A) are considered. For example, dimethylethanolamine has two potentially coordinating atoms per molecule (N and O). The upper limit of coordination sites at the copper atoms is 6 (but may be well below that number because the carboxylates may remain in the coordination sphere of the copper atoms, see e.g. the binuclear structure of Cu(II)-acetate monohydrate ([Cu₂(ac)₂(H₂O)₂]). In order to completely saturate the 6 potential coordination sites of one mole copper, 3 mol dimethylethanolamine would be required, that is, a molar ratio of dimethylethanolamine to Cu of >3:1 would be suitable.

It might be also suitable to determine the presence of unbound tertiary amino compound (A) by determining whether unbound tertiary amino compound (A) can be evaporated from the inventive composition suitably in vacuo, such as a pressure of less than 100 mm Hg, e.g. at a temperature in the range of 25 to 150° C.

Surprisingly it has been found that the mere admixture of the copper(II)-compound (B) with the tertiary amino compound (A) form homogeneous liquids at room temperature which are synergistically catalytic in particular in the formation of polyurethanes.

Preferably the compositions according to the invention form a homogenous liquid at room temperature (about 25° C.). Preferably such compositions after preparation, in particular by mixing the components with each other, and standing at room temperature (about 25° C.) remain in this condition of homogeneous liquid for at least 14 days, preferably for at least one month.

In a preferred embodiment of the invention the at least one tertiary amino compound (A) has at least one further functional group, which is preferably selected from hydroxyl (—OH), ether (—O—), amide, carbamate, primary, secondary or tertiary amino groups, more preferably the tertiary amino compound (A) comprises at least one group selected from hydroxyl (—OH) and ether (—O—) groups, an even more preferred tertiary amino compound (A) comprises at least one hydroxyl (—OH) and at least one ether (—O—) group.

Preferably the additional functional group in the at least one tertiary amino compound (A) is capable of coordinating the Cu(II)-ion in the copper(II)-compound (B).

Preferably the copper(II)-compound (B) is selected from Cu(II)-carboxylates or hydrates thereof, more preferably copper(II)-acetate or hydrates thereof.

In the compositions according to the invention preferably the molar ratio of the total of the molar amount of the tertiary amino groups and the molar amount of the optional further functional groups in the tertiary amino compound to the molar amount of Cu(II) present in the composition (Σ (mol tert. amino groups+mol optional functional groups)/mol Cu(II)) is more than 4:1, preferably more than 6:1, most preferably more than 10:1.

Further preferably in the compositions according to the invention the amount of the tertiary amino compound(s) (A) is such that the tertiary amino compound(s) (A) is capable to dissolve the copper(II)-compound(s) (B), to form a homogenous liquid at room temperature (about 25° C.).

The molar ratio of the tertiary amino compound (A) to the copper(II)-compound (B) in the compositions according to the invention is >2, preferably >3, more preferably >4. Most preferred are compositions according to the invention, wherein the copper(II)-compound (B) is copper(II)-acetate or hydrates thereof.

The tertiary amino compound (A) include the use of a single tertiary amino compound (A) or of a mixture of one or more of those the tertiary amino compounds (A).

Preferably the tertiary amino compounds (A) are selected from the group consisting of:
i. Tertiary amino compounds having at least one further amino group, selected from primary, secondary and tertiary amino groups.
ii. Tertiary amino compounds having at least one hydroxyl group, wherein the number of carbon atoms connecting the nitrogen atom of the tertiary amino group and the oxygen atom of the hydroxyl group is at least 2 except 3.
iii. Tertiary amino compounds having at least one ether group, wherein the number of carbon atoms connecting the nitrogen atom of the tertiary amino group and the oxygen atom of the ether group is at least 2,

and mixtures thereof. Further preferred the tertiary amino compounds (A) are selected from aliphatic saturated tertiary amines which do not comprise any multiple bond.

In the following particular preferred tertiary amino compounds (A) are shown:

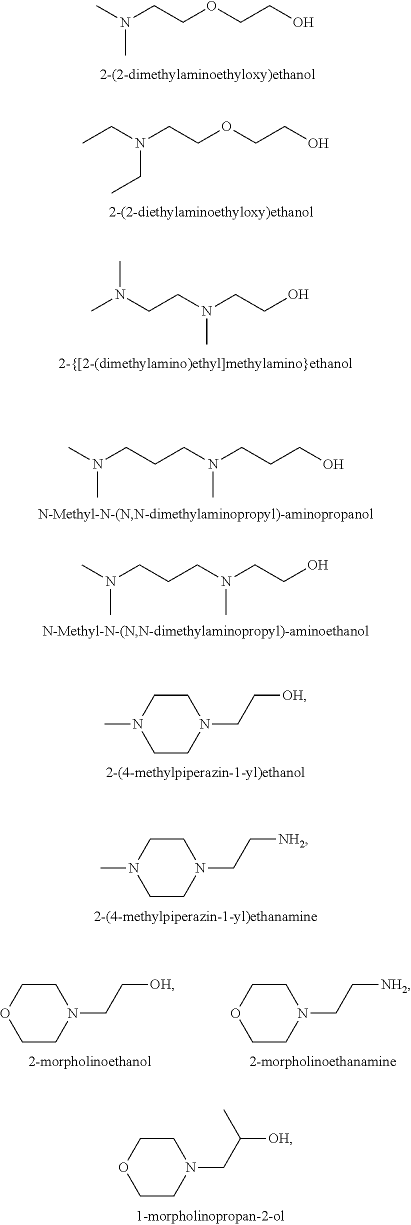

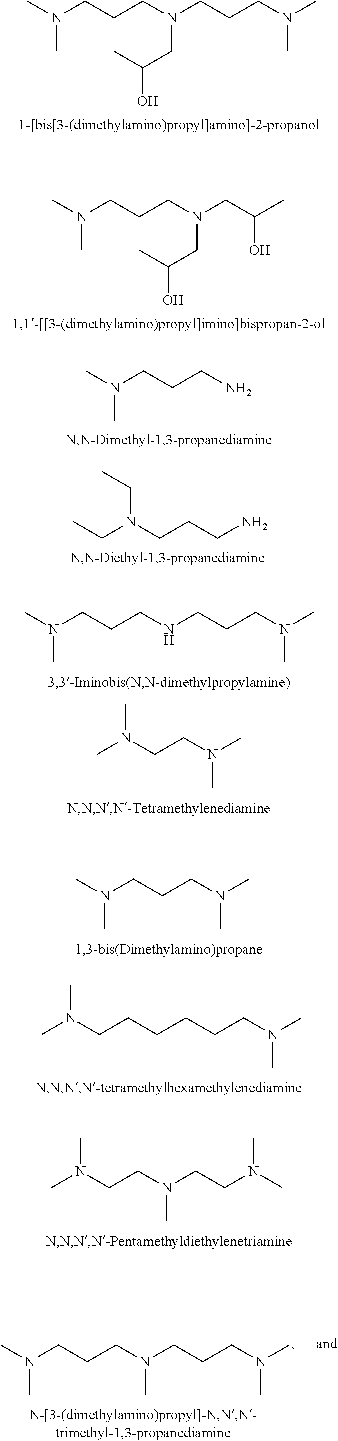

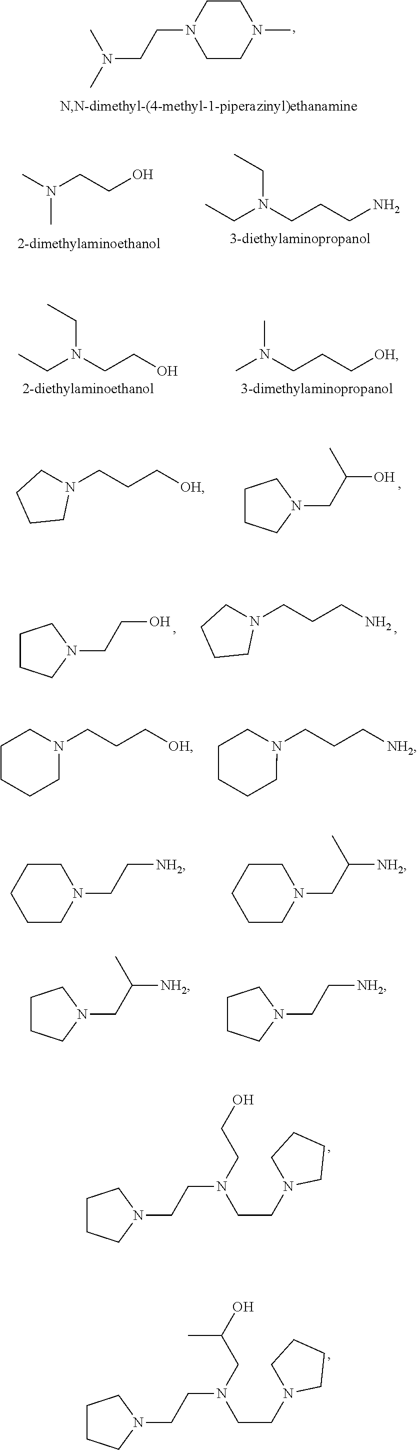

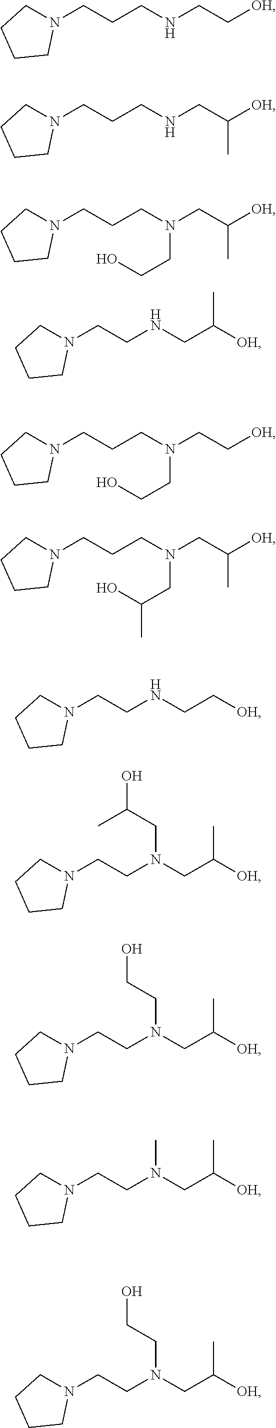

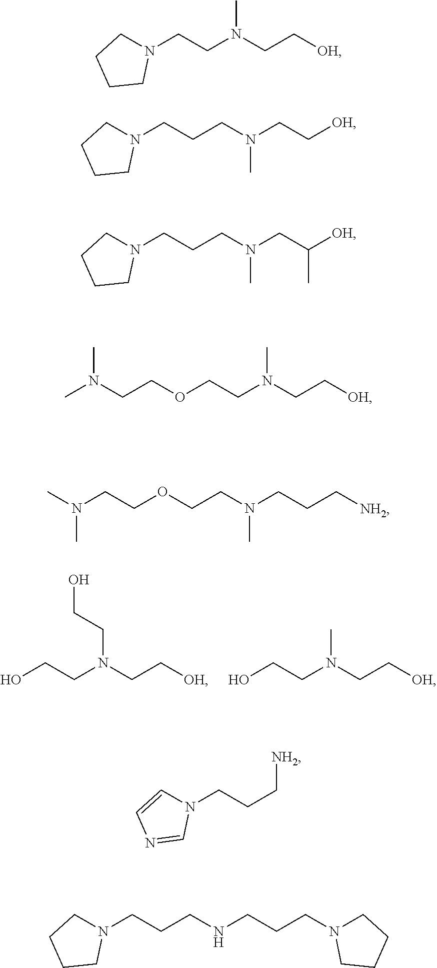

and mixtures thereof. The most preferred tertiary amino compound (A) is 2-[2-(dimethylamino)ethoxy]ethanol.

The compositions according to the invention are obtainable by mixing the at least one tertiary amino compound (A), and at least one copper(II)-compound (B) selected from the group consisting of and Cu(II)-carboxylates and hydrates thereof, in an amount that said compositions comprise unbound tertiary amino compound (A), preferably as homogeneous solutions at room temperature (25° C.). In accordance with the invention the compositions can further comprise one or more auxiliary components (C). It is possible that those auxiliary components (C) can conveniently be added at the preparation of the compositions according to the invention. Such auxiliary components (C) our preferably selected from reactants and additives for polyurethanes formation and from additives for polyurethanes.

Specifically, the auxiliary component (C) can be selected from the group consisting of:

polyols, such as
i. polyether polyols derived from the reaction of polyaromatic alcohols with alkylene oxides, e.g. ethylene oxide, propylene oxide, etc.
ii. polyether polyols derived from the reaction of ring-opening polymerization of tetrahydrofurane;
iii. polyether polyols derived from the reaction of ammonia and/or an amine with alkylene oxides, e.g. ethylene oxide, propylene oxide, etc.;
iv. polyester polyols derived from the reaction of a polyfunctional initiator, e.g. a diol, with a hydroxycarboxylic acid or lactone thereof, e.g. hydroxycaproic acid or epsilon-caprolactone;
v. polyester polyols derived from the reaction of a polyfunctional glycol, e.g. a diol, with a polyfunctional acid, e.g. adipic acid, succinic acid etc.;
vi. polyoxamate polyols derived from the reaction of an oxalate ester and a diamine, e.g. hydrazine, ethylenediamine, etc. directly in a polyether polyol;
vii. polyurea polyols derived from the reaction of a diisocyanate and a diamine, e.g. hydrazine, ethylenediamine, etc. directly in a polyether polyol.
viii. copolymer polyols also known as graft polyols, primary and secondary amine terminated polymers known as polyamines, etc.

diluents, such as
ix. water, glycols (ethylene glycol, di-, tri-ethylene glycol, propylene glycol, di-, tri-propylene glycol, 2-methyl-1,3-propanediol or others), mono- and di-alkyl ethers of glycols, etc.

polyurethane additives, such as
x. plasticizers;
xi. crosslinkers like glycerine, diethanolamine, triethanolamine and tetrahydroxyethylethylenediamine
xii. further conventional catalysts for polyurethane formation.
   and mixtures thereof, etc.

Polyurethane additives as an auxiliary component (C) further may comprise surfactants, fire retardants, chain extenders, a cross-linking agents, adhesion promoters, anti-static additives, hydrolysis stabilizers, UV stabilizers, lubricants, anti-microbial agents, or a combination of two or more thereof, etc.

The compositions according to the invention can comprise one or more diluents. Such diluents may be non-reactive or reactive diluents in respect to the subsequent use in polyurethane formation. In a particular embodiment the diluent is selected from isocyanate-reactive compounds or non-isocyanate-reactive compounds.

Particularly preferred are compositions according to the invention, which do not comprise any further diluent except for water in an amount that does not lead to precipitates at room temperature (about 25° C.). The presence of water in the compositions according to the invention is particularly useful because it acts as a blowing agent in the subsequent polyurethane formation reaction.

The process for the manufacture of the compositions according to the invention comprises preferably the step of mixing the at least one tertiary amino compound (A), and the at least one copper(II)-compound (B) selected from the group consisting of Cu(II)-carboxylates (B) and hydrates thereof, in an amount that said compositions comprise unbound tertiary amino compound, optionally in the presence of one or more auxiliary components (C). As mentioned before the mixing step is preferably performed at room temperature (25° C.), but also at elevated temperatures of more than 25° C. are possible in this step.

Particularly preferred compositions according to the invention comprise:
>50 to 98 parts by weight of the tertiary amino compound (A), and
2 to <50 parts by weight of the copper(II)-compound (B), and
based on 100 parts by weight of components (A) and (B): 0 to 2000 parts by weight of one or more auxiliary components (C),

The compositions according to the invention preferably comprise:
66 to 95 mol-% of the tertiary amino compound (A), and
5 to 34 mol-%, of the copper(II)-compound (B),

wherein the total amount of components (A) and (B) adds up to 100 mol-%.

The compositions according to the invention are preferably used as a catalyst. More preferred they are used as a catalyst for the reaction of at least one isocyanate compound with at least one isocyanate-reactive compound, and in particular they are used as a catalyst for the manufacture of polyisocyanate polyaddition products. Such polyisocyanate polyaddition products usually have one or more functional groups consisting of the group selected from urethane groups and urea groups.

A particularly preferred use of the compositions according to the invention includes their use as a catalyst for the manufacture of polyurethanes, in particular, of polyurethane foams where water is used as blowing agent or as co-blowing agent.

The present invention thus also relates to catalyst compositions comprising the inventive compositions.

The present invention further relates to a process for the manufacture of an isocyanate addition product comprising reacting an isocyanate compound with an isocyanate-reactive compound in the presence of the composition according to the invention as defined above. In such process preferably, the isocyanate compound is a polyisocyanate and the isocyanate-reactive compound is a polyol, and the process is for producing a polyurethane, preferably a polyurethane foam where water is used as blowing agent or co-blowing agent.

In particular the process for the manufacture of an isocyanate addition product according to the invention includes a process for the manufacture of a polyurethane, preferably a polyurethane foam, selected from cellular or non-cellular polyurethanes, and the process optionally comprises the use of a blowing agent, such as water.

The process for the manufacture of an isocyanate addition product according to any of the previous claims, wherein the process is for producing a polyurethane, and the process optionally comprises the addition of an auxiliary component (C), such as surfactants, fire retardants, chain extenders, cross-linking agents, adhesion promoters, anti-static additives, hydrolysis stabilizers, UV stabilizers, lubricants, anti-microbial agents, or a combination of two or more thereof.

In the process for the manufacture of an isocyanate addition product according to the invention the composition of the invention as defined above is preferably present in an amount of about 0.005 wt-% to about 5 wt-% based on the total weight of the total composition including all components.

The invention further relates to an isocyanate addition product forming a foam, obtainable from the process of the manufacture of an isocyanate addition product as defined above. Such isocyanate addition products forming a foam are preferably selected from the group consisting of slabstock, molded foams, flexible foams, rigid foams, semi-rigid foams, spray foams, thermoformable foams, microcellular foams, footwear foams, open-cell foams, closed-cell foams, adhesives.

A typical polyurethane foam-forming composition is for example described in WO2016/039856 and comprises: (a) a polyol; (b) an isocyanate; (c) the composition according to the invention, (d) a surfactant; and (e) optional components, such as a blowing agent and other optional components (C) such as surfactants, fire retardants, chain extenders, cross-linking agents, adhesion promoters, anti-static additives, hydrolysis and UV stabilizers, lubricants, anti-microbial agents, catalysts other than the composition according to the invention and/or other application specific additives can be used for production of compact or cellular polyurethane materials [The polyurethanes book, Editors David Randall and Steve Lee, John Willey & Sons, L T D, 2002]. The polyol (a) component may be any polyol useful to form a polyurethane foam.

In addition to the catalyst composition comprising the composition according to the invention as defined above, it is also possible to use one or more additional catalysts other than the composition according to the invention. Those additional catalysts can be added to the compositions according to the invention or they can be added separately the step of polyurethane formation. Those additional catalysts include state of the art polyurethane catalysts for instance (WO 2012/006263, page 22, [23]).

The term “polyurethane” as utilized herein refers to the reaction product of an isocyanate containing two or more isocyanate groups with compounds containing two or more active hydrogens, e.g. polyols (polyether polyols, polyester polyols, copolymer polyols also known as graft polyols) and/or primary and secondary amine terminated polymer known as polyamines. These reaction products are generally known to those skilled in the art as polyurethanes and/or polyureas. The reaction in forming cellular and non-cellular foams optionally includes a blowing agent. In the production of a polyurethane foam, the reaction includes a blowing agent and other optional components such as surfactants, fire retardants, chain extenders, cross-linking agents, adhesion promoters, anti-static additives, hydrolysis and UV stabilizers, lubricants, anti-microbial agents, catalysts and/or other application specific additives can be used for production of compact or cellular polyurethane materials [The polyurethanes book, Editors David Randall and Steve Lee, John Willey & Sons, LTD, 2002]. Typically, ethylene glycol, di-, tri-ethylene glycol, propylene glycol, di-, tri-propylene glycol, 2-methyl-1,3-propanediol or other diols are known to be used as chain extenders. The present catalyst materials of the invention are especially suitable for making flexible, semi-flexible, and rigid foams using the one shot foaming, the quasi-pre-polymer and the pre-polymer processes. The polyurethane manufacturing process of the present invention typically involves the reaction of, e.g. a polyol, generally a polyol having a hydroxyl number from about 10 to about 700, an organic polyisocyanate, a blowing agent and optional additives known to those skilled in the art and one or more catalysts, at least one of which is chosen from the composition according to the invention. As the blowing agent and optional additives, flexible and semi-flexible foam formulations (hereinafter referred to simply as flexible foams) also generally include, e.g. water, organic low boiling auxiliary blowing agent or an optional non-reacting gas, silicone surfactants, optional catalysts other than the composition according to the invention, and optional cross-linker(s). Rigid foam formulations often contain both a low boiling organic material and water for blowing.

The “one shot foam process” for making polyurethane foam is a one-step process in which all of the ingredients necessary (or desired) for producing the foamed polyurethane product including the polyisocyanate, the organic polyol, water, catalysts other than the composition according to the invention, surfactant(s), optional blowing agents and the like are efficiently mixed, poured onto a moving conveyor or into a mold of a suitable configuration and cured [Chemistry and Technology of Polyols for Polyurethanes, by Mihail Ionescu, Rapra Technology LTD. (2005)]. The one shot process is to be contrasted with the prepolymer and quasi-prepolymer processes [Flexible polyurethane foams, by Ron Herrington and Kathy Hock, Dow Plastics, 1997]. In the prepolymer process, most prepolymers in use today are isocyanate-tipped. A strict prepolymer is formed when just enough polyisocyanate is added to react with all hydroxyl sites available. If there is an excess or residual isocyanate monomer present, the product is called a quasi-prepolymer. A prepolymer or a quasi-prepolymer is first prepared in the absence of any foam-generating constituents. In a second step, the high molecular weight polyurethanes materials are formed by the reaction of a pre-polymer with water and/or chain extender such as: ethylene glycol, diethylene glycol, 1,4-butane diol or a diamine in the presence of catalyst.

The composition of the invention may be used as a sole catalyst or in combination with one or more one or more additional catalysts for the formation of polyisocyanate addition products such as tertiary amines such as the alkyl amines described above, organometallic catalysts, e.g. organotin catalysts, metal salt catalysts, e.g. alkali metal or alkaline earth metal carboxylate catalysts, other delayed action catalysts, or other known polyurethane catalysts. Organometallic catalysts or metal salt catalysts also can, and often are, used in polyurethane foam formulations. For example, for flexible slabstock foams, the generally preferred metal salt and organometallic catalysts are stannous octoate and dibutyltin dilaurate respectively. For flexible molded foams, exemplary organometallic catalysts are dibutyltin dilaurate and dibutyltin dialkylmercaptide. For rigid foams exemplary metal salt and organometallic catalysts are potassium acetate, potassium octoate and dibutyltin dilaurate, respectively. Metal salt or organometallic catalysts normally are used in small amounts in polyurethane formulations, typically from about 0.001 parts per hundred parts (pphp) to about 0.5 phpp based on the total weight of the composition.

Polyols which are particularly useful in the process of the invention for making a polyurethane, particularly via the one-shot foaming procedure, are any of the types presently employed in the art for the preparation of flexible slabstock foams, flexible molded foams, semi-flexible foams, and rigid foams. Such polyols are typically liquids at ambient temperatures and pressures and include polyether polyols and polyester polyols having hydroxyl numbers in the range of from about 15 to about 700. The hydroxyl numbers are preferably between about 20 to about 60 for flexible foams, between about 100 to about 300 for semi-flexible foams and between about 250 to about 700 for rigid foams.

For flexible foams the preferred functionality, i.e. the average number of hydroxyl groups per molecule of polyol, of the polyols is about 2 to about 4 and most preferably about 2.3 to about 3.5. For rigid foams, the preferred functionality is about 2 to about 8 and most preferably about 3 to about 5.

Polyfunctional isocyanate-reactive compounds which can be used in the process for manufacturing the polyurethanes and/or polyureas in the presence of the catalyst composition of the invention, alone or in admixture as copolymers, include for example any of the following non-limiting classes of polyols:

(a) polyether polyols derived from the reaction of polyhydroxyalkanes with one or more alkylene oxides, e.g. ethylene oxide, propylene oxide, etc.;

(b) polyether polyols derived from the reaction of high-functionality alcohols, sugar alcohols, saccharides and/or high functionality amines, if desired in admixture with low-functionality alcohols and/or amines with alkylene oxides, e.g. ethylene oxide, propylene oxide, etc.;

(c) polyether polyols derived from the reaction of phosphorus and polyphosphorous acids with alkylene oxides, e.g. ethylene oxide, propylene oxide, etc.,

(d) polyether polyols derived from the reaction of polyaromatic alcohols with alkylene oxides, e.g. ethylene oxide, propylene oxide, etc.;

(e) polyether polyols derived from the reaction of ring-opening polymerization of tetrahydrofurane;

(f) polyether polyols derived from the reaction of ammonia and/or an amine with alkylene oxides, e.g. ethylene oxide, propylene oxide, etc.;

(g) polyester polyols derived from the reaction of a polyfunctional initiator, e.g. a diol, with a hydroxycarboxylic acid or lactone thereof, e.g. hydroxycaproic acid or e-caprolactone;

(g) polyester polyols derived from the reaction of a polyfunctional diol, e.g. ethylene glycol, di-ethylene glycol, 1,4-butane diol, 1,3-propane diol, 1,2-propane diol, 2-methyl-1,3-propanediol, with a polyfunctional acid, e.g. adipic acid, succinic acid, sebacic acid, phthalic acid, terephthalic acid, isophthalic acid; (h) polyoxamate polyols derived from the reaction of an oxalate ester and a diamine, e.g. hydrazine, ethylenediamine, etc. directly in a polyether polyol;

(i) polyurea polyols derived from the reaction of a diisocyanate and a diamine, e.g. hydrazine, ethylenediamine, etc. directly in a polyether polyol.

For flexible foams, preferred types of alkylene oxide adducts of polyhydroxyalkanes are the ethylene oxide and propylene oxide adducts of aliphatic triols such as glycerol, trimethylol propane, etc. For rigid foams, the preferred class of alkylene oxide adducts are the ethylene oxide and propylene oxide adducts of ammonia, toluene diamine, sucrose, and phenol-formaldehyde-amine resins (Mannich bases).

Grafted or polymer polyols are used extensively in the production of flexible foams and are, along with standard polyols, one of the preferred class of polyols useful in the process of this invention. Polymer polyols are polyols that contain a stable dispersion of a polymer, for example in the polyols a) to e) above and more preferably the polyols of type a). Other polymer polyols useful in the process of this invention are polyurea polyols and polyoxamate polyols.

The polyisocyanates that are useful in the polyurethane foam formation process of this invention are organic compounds that contain at least two isocyanate groups and generally will be any of the known aromatic or aliphatic polyisocyanates. Suitable organic polyisocyanates include, for example, the hydrocarbon diisocyanates, (e.g. the alkylenediisocyanates and the arylene diisocyanates), such as methylene diphenyl diisocyanate (MDI) and 2,4- and 2,6-toluene diisocyanate (TDI), as well as known triisocyanates and polymethylene poly(phenylene isocyanates) also known as polymeric or crude MDI. For flexible and semi-flexible foams, the preferred isocyanates generally are, e.g. mixtures of 2,4-tolylene diisocyanate and 2,6-tolylene diisocyanate (TDI) in proportions by weight of about 80% and about 20% respectively and also about 65% and about 35% respectively based on the total weight of the composition of TDI; mixtures of TDI and polymeric MDI, preferably in the proportion by weight of about 80% TDI and about 20% of crude polymeric MDI to about 50% TDI and about 50% crude polymeric MDI based on the total weight of the composition; and all polyisocyanates of the MDI type. For rigid foams, the preferred isocyanates are, e.g. polyisocyanates of the MDI type and preferably crude polymeric MDI.

The amount of polyisocyanate included in the foam formulations used relative to the amount of other materials in the formulations is described in terms of “Isocyanate Index”. “Isocyanate Index” means the actual amount of polyisocyanate used divided by the theoretically required stoichiometric amount of polyisocyanate required to react with all the active hydrogen in the reaction mixture multiplied by one hundred (100) [see Oertel, Polyurethane Handbook, Hanser Publishers, New York, N.Y. (1985)]. The Isocyanate Indices in the reaction mixtures used in the process of this invention generally are between 60 and 140. More usually, the Isocyanate Index is: for flexible TDI foams, typically between 85 and 120; for molded TDI foams, normally between 90 and 105; for molded MDI foams, most often between 70 and 90; and for rigid MDI foams, generally between 90 and 130. Some examples of polyisocyanurate rigid foams are produced at isocyanate indices as high as 250-400.

Water often is used as a reactive blowing agent in both flexible and rigid foams. In the production of flexible slabstock foams, water generally can be used in concentrations of, e.g. between 2 to 6.5 parts per hundred parts (pphp) of polyol blend, and more often between 3.5 to 5.5 pphp of polyol blend. Water levels for TDI molded foams normally range, e.g. from 3 to 4.5 pphp of polyol blend. For MDI molded foam, the water level, for example, is more normally between 2.5 and 5 pphp. Water levels for rigid foam, for example, range from 0.5 to 5 pphp, and more often from 0.5 to 2 pphp of polyol blend. Physical blowing agents such as blowing agents based on volatile hydrocarbons or halogenated hydrocarbons and other non-reacting gases can also be used in the production of polyurethane foams in accordance with the present invention. A significant proportion of the rigid insulation foam produced is blown with volatile hydrocarbons or halogenated hydrocarbons and the preferred blowing agents are the hydrochlorofluorocarbons (HCFC) and the volatile hydrocarbons pentane and cyclopentane. In the production of flexible slabstock foams, water is the main blowing agent; however, other blowing agents can be used as auxiliary blowing agents. For flexible slabstock foams, the preferred auxiliary blowing agents are carbon dioxide and dichloromethane (methylene chloride). Other blowing agents may also be used such as, e.g. the chlorofluorocarbon (CFC) and the trichloromonofluoromethane (CFC-11).

Flexible molded foams typically do not use an inert, auxiliary blowing agent, and in any event incorporate less auxiliary blowing agents than slabstock foams. However, there is a great interest in the use of carbon dioxide in some molded technology. MDI molded foams in Asia and in some developing countries use methylene chloride, CFC-11 and other blowing agents. The quantity of blowing agent varies according to the desired foam density and foam hardness as recognized by those skilled in the art. When used, the amount of hydrocarbon-type blowing agent varies from, e.g. a trace amount up to about 50 parts per hundred parts of polyol blend (pphp) and CO₂ varies from, e.g. about 1 to about 10 pphp of polyol blend. Crosslinkers also may be used in the production of polyurethane foams. Crosslinkers are typically small molecules; usually less than 350 molecular weight, which contain active hydrogens for reaction with the isocyanate. The functionality of a crosslinker is greater than 3 and preferably between 3 and 5. The amount of crosslinker used can vary between about 0.1 pphp and about 20 pphp based on polyol blend and the amount used is adjusted to achieve the required foam stabilization or foam hardness. Examples of crosslinkers include glycerine, diethanolamine, triethanolamine and tetrahydroxyethylethylenediamine.

Silicone surfactants that may be used in the process of this invention include, e.g. “hydrolysable” polysiloxane-polyoxyalkylene block copolymers, “non-hydrolysable” polysiloxane-polyoxyalkylene block copolymers, cyanoalkylpolysiloxanes, alkylpolysiloxanes, and polydimethylsiloxane oils. The type of silicone surfactant used and the amount required depend on the type of foam produced as recognized by those skilled in the art. Silicone surfactants can be used as such or dissolved in solvents such as glycols. For flexible slabstock foams, the reaction mixture usually contains a level of silicone surfactant from about 0.1 to about 6 pphp, and more often from about 0.7 to about 2.5 pphp. For flexible molded foam the reaction mixture usually contains a level of silicone surfactant from about 0.1 to about 5 pphp, and more often from about 0.5 to about 2.5 pphp. For rigid foams, the reaction mixture usually contains a level of silicone surfactant from about 0.1 to about 5 pphp of silicone surfactant, and more often from about 0.5 to about 3.5 pphp. The amount used is adjusted to achieve the required foam cell structure and foam stabilization.

Temperatures useful for the production of polyurethanes vary depending on the type of foam and specific process used for production as well understood by those skilled in the art.

Flexible slabstock foams are usually produced by mixing the reactants generally at an ambient temperature of between about 20° C. and about 40° C. The conveyor on which the foam rises and cures is essentially at ambient temperature, which temperature can vary significantly depending on the geographical area where the foam is made and the time of year. Flexible molded foams usually are produced by mixing the reactants at temperatures between about 20° C. and about 30° C., and more often between about 20° C. and about 25° C. The mixed starting materials are fed into a mold typically by pouring. The mold preferably is heated to a temperature between about 20° C. and about 70° C., and more often between about 40° C. and about 65° C. Sprayed rigid foam starting materials are mixed and sprayed at ambient temperature. Molded rigid foam starting materials are mixed at a temperature in the range of about 20° C. to about 35° C. The preferred process used for the production of flexible slabstock foams, molded foams, and rigid foams in accordance with the present invention is the “one-shot” process where the starting materials are mixed and reacted in one step.

In the following the preferred embodiments of the invention are summarized:

1. Compositions comprising (A) at least one tertiary amino compound, and (B) at least one copper(II)-compound, selected from the group consisting of Cu(II)-carboxylates, hydrates and adducts with said tertiary amino compound (A) thereof, wherein said compositions comprise unbound tertiary amino compound (A).

2. Compositions according to embodiment 1, wherein the weight ratio of the tertiary amine compound (A) to the Cu(II)-compound (B) is >2:1, preferably >4:1, more preferably >9:1, and most preferably >19:1.

3. Compositions according to any of the previous embodiments, which form a homogenous liquid at room temperature (about 25° C.).

4. Compositions according to embodiment 3, which form a homogeneous liquid after preparation and standing at room temperature (about 25° C.) for at least 14 days.

5. Compositions according to any of the previous embodiments, wherein the at least one tertiary amino compound (A) has at least one further functional group.

6. Compositions according to the previous embodiment, wherein the functional group is selected from hydroxyl (—OH), ether (—O—), amide, carbamate, primary, secondary or tertiary amino groups.

7. Compositions according to the previous embodiments 5 or 6, wherein the functional group is capable of coordinating the Cu(II)-ion.

8. Compositions according to any of the previous embodiments, wherein the copper(II)-compound (B) is selected from Cu(II)-carboxylates (B), preferably copper(II)-acetate or hydrates thereof.

9. Compositions according to any of the previous claims, wherein the molar ratio of the total of the molar amount of the tertiary amino groups and the molar amount of the optional further functional groups in the tertiary amino compound to the molar amount of Cu(II) present in the composition (E (mol tert. amino groups+mol optional functional groups)/mol Cu(II)), is more than 4:1, preferably more than 6:1, most preferably more than 10:1.

10. Compositions according to any of the previous embodiments, wherein the amount of the tertiary amino compound(s) (A) is such that the tertiary amino compound(s) (A) is capable to dissolve the copper(II)-compound(s) (B), to form a homogenous liquid at room temperature (about 25° C.).

11. Compositions according to any of the previous embodiments, wherein the molar ratio of the tertiary amino compound (A) to the copper(II)-compound (B) is >2, preferably >3, more preferably >4.

12. Compositions according to any of the previous embodiments, wherein the copper(II)-compound (B) is copper(II)-acetate or hydrates thereof.

13. Compositions according to any of the previous embodiments, wherein the tertiary amino compounds (A) are selected from the group consisting of:

i. Tertiary amino compounds having at least one further amino group, selected from primary, secondary and tertiary amino groups.

ii. Tertiary amino compounds having at least one hydroxyl group, wherein the number of carbon atoms connecting the nitrogen atom of the tertiary amino group and the oxygen atom of the hydroxyl group is at least 2 except 3.

iii. Tertiary amino compounds having at least one ether group, wherein the number of carbon atoms connecting the nitrogen atom of the tertiary amino group and the oxygen atom of the ether group is at least 2.

14. Compositions according to any of the previous embodiments, wherein the tertiary amino compounds (A) are selected from aliphatic saturated tertiary amines which do not comprise any multiple bond.

15. Compositions according to any of the previous embodiments, wherein the tertiary amino compounds (A) are selected from the group consisting of:

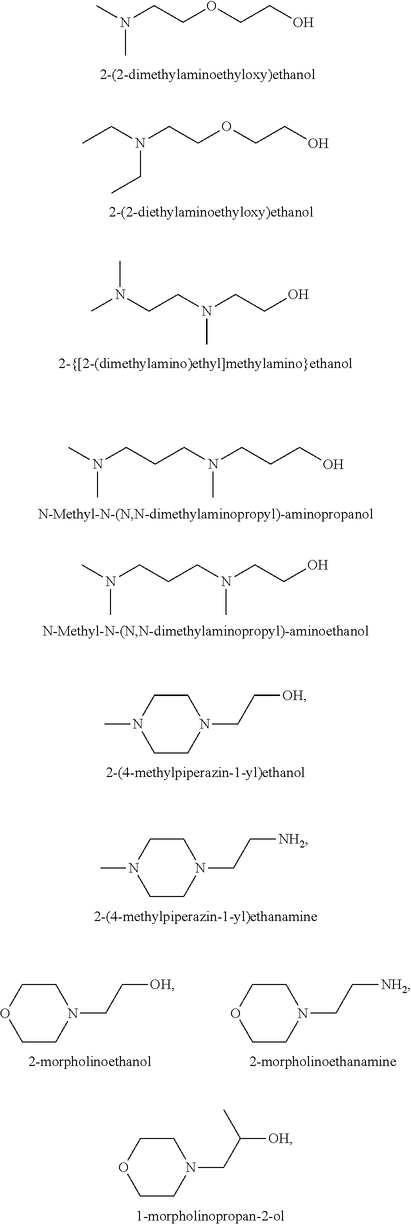

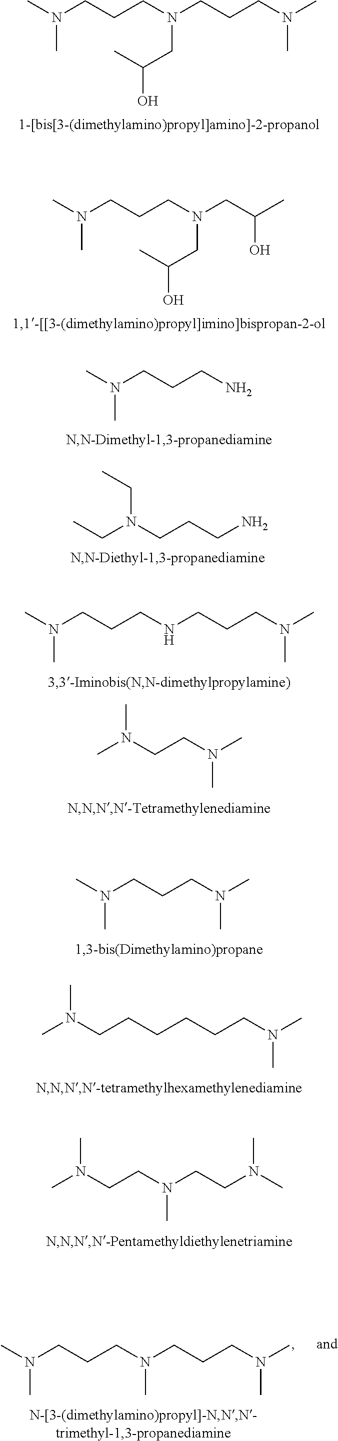

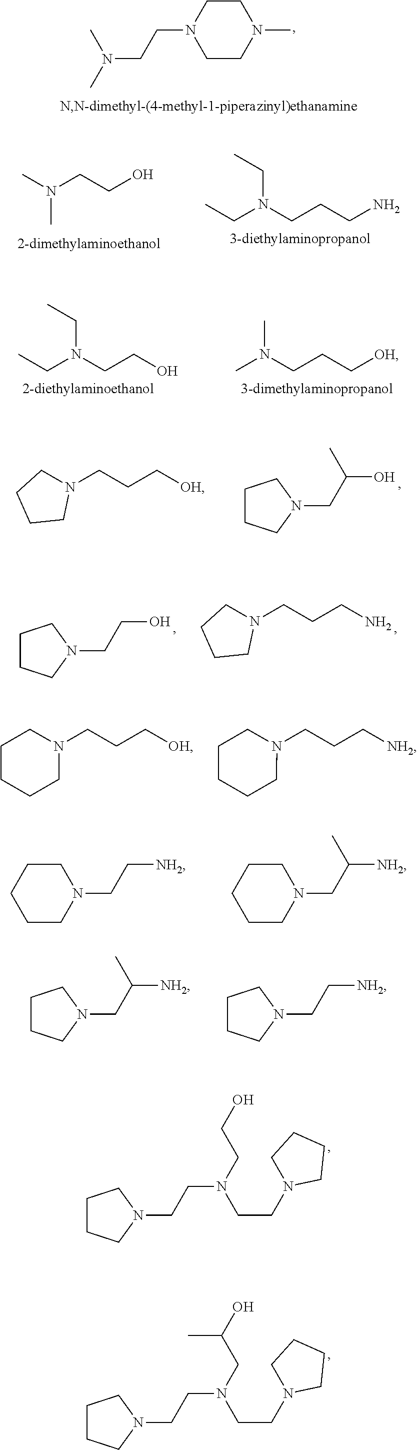

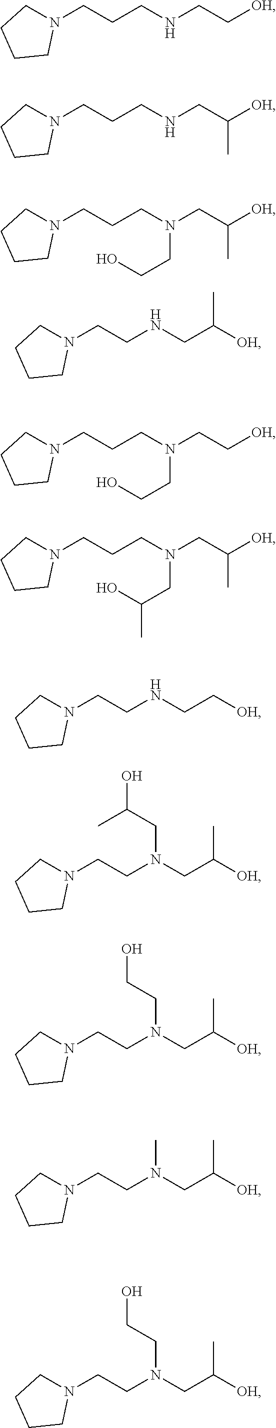

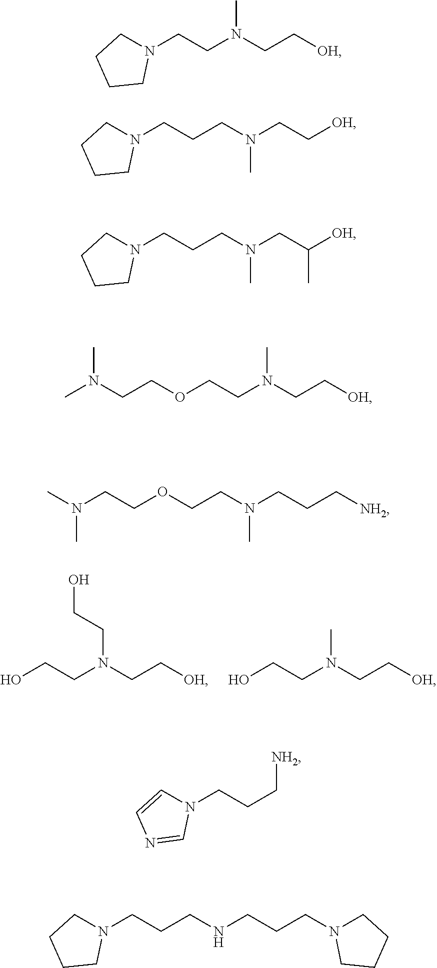

and mixtures thereof.

16. Compositions according to any of the previous embodiments obtainable by mixing at least one tertiary amino compound (A), and at least one copper(II)-compound (B) selected from the group consisting of Cu(II)-carboxylates (B) and hydrates thereof, in an amount that said compositions comprise unbound tertiary amino compound (A).

17. Compositions according to any of the previous embodiments, further comprising one or more auxiliary components (C).

18. Compositions according to the previous embodiment, wherein the auxiliary components (C) is selected from reactants and additives for polyurethanes formation and additives for polyurethanes.

19. Compositions according to the previous embodiment, wherein component (C) is selected from the group consisting of:

polyols, such as

i. polyether polyols derived from the reaction of polyaromatic alcohols with alkylene oxides, e.g. ethylene oxide, propylene oxide, etc.

ii. polyether polyols derived from the reaction of ring-opening polymerization of tetrahydrofurane;

iii. polyether polyols derived from the reaction of ammonia and/or an amine with alkylene oxides, e.g. ethylene oxide, propylene oxide, etc.;

iv. polyester polyols derived from the reaction of a polyfunctional initiator, e.g., a diol, with a hydroxycarboxylic acid or lactone thereof, e.g. hydroxycaproic acid or epsilon-caprolactone;

v. polyester polyols derived from the reaction of a polyfunctional glycol, e.g., a diol, with a polyfunctional acid, e.g. adipic acid, succinic acid etc.;

vi. polyoxamate polyols derived from the reaction of an oxalate ester and a diamine, e.g., hydrazine, ethylenediamine, etc. directly in a polyether polyol;

vii. polyurea polyols derived from the reaction of a diisocyanate and a diamine, e.g. hydrazine, ethylenediamine, etc. directly in a polyether polyol.

viii. copolymer polyols also known as graft polyols, primary and secondary amine terminated polymers known as polyamines,

diluents, such as

ix. water, glycols (ethylene glycol, di-, tri-ethylene glycol, propylene glycol, di-, tri-propylene glycol, 2-methyl-1,3-propanediol or others), mono- and di-alkyl ethers of glycols, polyurethane additives, such as

x. plasticizers;

xi. crosslinkers like glycerine, diethanolamine, triethanolamine and tetrahydroxyethylethylenediamine

xii. further conventional catalysts for polyurethane formation other than the inventive composition

and mixtures thereof

20. Compositions according to any of the previous embodiments, comprising one or more diluents.

21. Compositions according to the previous embodiment, wherein the diluent is selected from isocyanate-reactive compounds or non-isocyanate-reactive compounds.

22. Compositions according to any of the previous embodiments 1 to 18, which do not comprise any further diluent except for water in an amount that does not lead to precipitates at room temperature (about 25° C.).

23. A process for the manufacture of the compositions according to any of the previous embodiments, which comprises the step of mixing at least one tertiary amino compound (A), and at least one copper(II)-compound (B) selected from the group consisting of Cu(II)-carboxylates (B) and hydrates thereof, in an amount that said compositions comprise unbound tertiary amino compound, optionally in the presence of one or more auxiliary components (C).

24. Compositions according to any of the previous embodiments, comprising:

>50 to 98 parts by weight of the tertiary amino compound (A), and

2 to <50 parts by weight of the copper(II)-compound (B),

and based on 100 parts by weight of components (A) and (B):

0 to 2000 parts by weight one or more auxiliary components (C),

25. Compositions according to any of the previous embodiments, comprising:

66 to 95 mol-% of the tertiary amino compound (A), and

5 to 34 mol-%, of the copper(II)-compound (B),

wherein the total amount of components (A) and (B) adds up to 100 mol-%.

26. Use of the compositions according to any of the previous embodiments as a catalyst.

27. Use according to the previous embodiment as a catalyst for the reaction of at least one isocyanate compound with at least one isocyanate-reactive compound, such as hydroxy- and/or amino-functional compounds.

28. Use according to the previous embodiments as a catalyst for the manufacture of polyisocyanate polyaddition products comprising for example at least one carbamate (urethane) (from the reaction with a hydroxy-functional compound) and/or urea group (from the reaction of an amino-functional compound), preferably the polyisocyanate polyaddition products are polyurethanes.

29. Use according to the previous embodiments wherein the polyisocyanate polyaddition products have one or more functional groups consisting of the group selected from urethane groups and urea groups.

30. Use according to the previous embodiments as a catalyst for the manufacture of polyurethanes, in particular polyurethane foams where water is used as blowing agent or as co-blowing agent.

31. A catalyst composition comprising the composition according to any of the previous embodiments.

32. A process for the manufacture of an isocyanate addition product comprising reacting an isocyanate compound with an isocyanate-reactive compound in the presence of the composition as defined in any of the previous embodiments.

33. The process for the manufacture of an isocyanate addition product, according to embodiment 32, wherein the isocyanate is a polyisocyanate and the isocyanate-reactive compound is a polyol, and the process is for producing a polyurethane, in particular a polyurethane foam where water is used as blowing agent or co-blowing agent.

34. The process for the manufacture of an isocyanate addition product according to any of the previous embodiments, wherein the isocyanate addition product is a polyurethane, preferably a polyurethane foam, selected from cellular or non-cellular polyurethanes, and the process optionally comprises a blowing agent, such as water.

35. The process for the manufacture of an isocyanate addition product according to any of the previous embodiments, wherein the process is for producing a polyurethane, and the process optionally comprises the addition of an auxiliary component (C), such as surfactants, fire retardants, chain extenders, cross-linking agents, adhesion promoters, anti-static additives, hydrolysis stabilizers, UV stabilizers, lubricants, anti-microbial agents, or a combination of two or more thereof.

36. The process for the manufacture of an isocyanate addition product according to any of the previous embodiments, wherein the composition as defined in any of the previous embodiments is present in an amount of about 0.005 wt-% to about 5 wt-% based on the total weight of the total composition including all components.

37. An isocyanate addition product forming a foam obtainable from the process of the manufacture of an isocyanate addition product of any of the previous embodiments.

38. An isocyanate addition product forming a foam according to the previous embodiment, selected from the group consisting of slabstock, molded foams, flexible foams, rigid foams, semi-rigid foams, spray foams, thermoformable foams, microcellular foams, footwear foams, open-cell foams, closed-cell foams, adhesives.

While the scope of the present invention is defined by the appended claims, the following examples illustrate certain aspects of the invention and, more particularly, describe methods for evaluation. The examples are presented for illustrative purposes and are not to be construed as limitations on the present invention.

### EXAMPLES

### Catalyst Formation Examples

2-[2-(Dimethylamino)ethoxy]ethanol (DMEE) was used as catalyst in Comparative Examples 1, 2 and 3.

Catalyst 1:

57.00 g 2-(2-dimethylaminoethoxy)ethanol (428.0 mmol) was added to 3.00 g Cu(II) acetate monohydrate (15.0 mmol) at room temperature and the mixture was homogenized by roller mixer at room temperature to obtain blue, homogeneous liquid mixture. The mixture was kept in hermetically closed flask and used as a catalyst to prepare polyurethane foams.

Catalyst 2:

21.93 g 2-(2-dimethylaminoethoxy)ethanol (164.6 mmol) was added to 3.07 g Cu(II) acetate monohydrate (15.4 mmol) at room temperature and the mixture was homogenized by roller mixer at room temperature to obtain blue, homogeneous liquid mixture. The mixture was kept in hermetically closed flask and was used as a catalyst to prepare polyurethane foams.

### Polyurethane Foaming Examples

The polyurethane foams were prepared according to the following procedure. For each series of trials represented by each of the following Tables 1, 2 and 3 individual fresh premixes were prepared. A premix of a reactive polyether polyol (Hyperlite® 1629; hydroxyl number of 29.5-33.5 mg KOH/g), a reactive polyether polyol modified with a styrene-acrylonitrile polymer (Hyperlite® 1639; hydroxyl number of 16.5-20.5 mg KOH/g), 90 wt-% aqueous solution of diethanolamine (DEOA 90 wt-% in water), silicone stabilizer (Niax® Silicone L-3555), and water was prepared according to the Tables 1, 2 and 3 (in weight parts). The premix was homogenized thoroughly in a plastic container for 20 minutes using propeller stirrer with ring at 1500 rpm. From the homogenized premix, several batches each of 318.30 g were weighed to an appropriate mixing plastic container and corresponding catalysts compositions were consequently added to obtain fully formulated polyol blends. The fully formulated polyol blend was mixed thoroughly in the plastic container for 30 seconds using propeller stirrer with ring at 3000 rpm. 129.3 g Sucranate T80 isocyanate (TDI, with NCO content of 48.1%) was added and the reactive mixture was mixed for 4-6 seconds. The reactive mixture was immediately poured into a 30×30×10 cm aluminum mold and the mold was immediately closed and clamped. The mold lid had four vent openings with a diameter of 0.4 mm at the four corners. The mold temperature was controlled at 65° C. via a hot water circulating thermostat. Release agent Chem-Trend® PU-1705M was used to coat the mold. Foams were demolded after 5 minutes. The processing and physical characteristics of the foam were evaluated as follows:

| Physical | |
|---|---|
| Characteristic | Test Method |
| Density | ASTM D 3574 -05 |
| Exit Time | Exit time is the time elapsed, in seconds, from the addition of the isocyanate to |
| | the reaction mixture to the first appearance of foam extrusion from the four |
| | vents of the mold. |
| Force-to-Crush | ASTM 3574-05. Force-to-crush (FTC) is the peak force required to deflect a |
| FTC, N | foam pad with the standard 323 cm² (50 sq. in.) indentor, 1 minute after |
| | demold, to 50% of its original thickness. It is measured with a load-testing |
| | machine using the same setup as that used for measuring foam hardness. A |
| | load tester crosshead speed of 50.8 cm/minute is used. The FTC value is a |
| | good relative measure of the degree of cell openness characteristic of a foam, |
| | i.e., the lower the value, the more open the foam. |
| Hot ILD | ASTM 3574-05. The indentation load deflection (hot ILD) is measured on the |
| | same pad used for the FTC measurement 3 minutes after demold. Following |
| | the FTC measurement, the foam pad is completely crushed by a mechanical |
| | crusher before the measurement of ILD at 50% compression is taken. The hot |
| | ILD value is a good relative measure of the curing degree of a foam 3 minutes |
| | after demold. The higher the hot ILD value, the higher the curing degree of the |
| | foam. |
| ILD | ASTM 3574-05. The indentation load deflection (ILD) is measured on the same |
| | pad used for the FTC and hot ILD measurements at least 48 hours after |
| | demold. Following the FTC and hot ILD measurements, the foam pad is |
| | completely crushed by a mechanical crusher before the measurement of ILD at |
| | 50% compression is taken. The ILD value is a good relative measure of the |
| | curing degree of a foam at least 48 hours after demold. The higher the ILD |
| | value, the higher the curing degree of the foam. |

For each experiment two foams were prepared and the presented data for exit time, force-to-crush, hot ILD, ILD and density represent the average value of repeat determinations.

Assessment of the catalytic performance of copper-based catalysts composition is performed by comparison of processing and physical characteristics, the hot ILD and ILD values, in particularly. Hot ILD values represent the load-bearing ability of the cellular material after demolding and crushing the foam to open cells. The higher the value, the firmer, the tighter and the better cured is the foam after demolding and crushing to open cells. The ILD value is a good relative measure of the curing degree of a foam at least 48 hours after demolding. The higher the ILD value, the higher the curing degree of the foam and the higher the hardness of the foam.

### Example 1—Comparative Example 1 (Table 1)

| Comparative Example | Example |
|---|---|
| 1 | 1 |

| | |
|---|---|
| Hyperlite ® 1629 | 50.00 |
| Hyperlite ® 1639 ® | 50.00 |
| 90 wt-% diethanolamine in water | 1.66 |
| Water added | 3.44 |
| Niax Silicone L-3555 | 1.00 |

| | | |
|---|---|---|
| DMEE | 0.60 | |
| Catalyst 1 | | 0.60 |

| | |
|---|---|
| TDI Scuranate T80 (NCO % = 48.1%) | 43.11 |

| | | |
|---|---|---|
| Exit time [seconds] | 45 | 41 |
| FTC [N] | 1301 | 1102 |
| hot ILD [N] | 167 | 172 |
| ILD [N] | 398 | 439 |
| Weight of the PU pad [gram] | 360 | 353 |
| Density [kg/m³] | 40 | 39 |

Surprisingly, it was found that the PU foam prepared by adding Cu(OAc)₂*H₂O to DMEE (Example 1) has significantly higher ILD value (439 N). The Comparative Example 1 prepared by using DMEE alone possesses an ILD value of 398 N. The higher ILD value demonstrating, that the force required to deflect the foam pad to 50% of its original thickness is higher, indicates that the inventive catalyst 1 composition provides beneficially better post-curing.

### Example 2 & Comparative Example 2 (Table 2)

| | Comparative Example | Example |
|---|---|---|
| | 2 | 2 |
| Hyperlite ® 1629 | 50.00 | |
| Hyperlite ® 1639 (43% SAN graft) | 50.00 | |
| DEOA (90 wt-% in Water) | 1.66 | |
| Water added | 3.44 | |
| Niax Silicone L-3555 | 1.00 | |
| DMEE | 0.60 | |
| Catalyst 2 | | 0.60 |
| TDI Scuranate T80 | 43.11 | |
| Exit time (s) | 38 | 39 |
| FTC, N | 1367 | 1208 |
| hot ILD, N | 183 | 205 |
| ILD, N | 388 | 483 |
| Weight [gram] | 359 | 357 |
| Density (kg/m³) | 40 | 40 |

Surprisingly, it was found that the PU foam prepared by adding Cu(OAc)₂*H₂O to DMEE (Example 2) has significantly higher ILD value (483 N), whereas the Comparative Example 2 prepared by using DMEE alone possesses an ILD value of 388 N. The higher ILD value demonstrating, that the force required to deflect the foam pad to 50% of its original thickness is higher, indicates that the inventive catalyst 2 composition provides beneficially better post-curing.

### Example 3 & Comparative Examples 3 (Table 3)

| Comparative Example | Example |
|---|---|
| 3 | 3 |

| | |
|---|---|
| Hyperlite ® 1629 | 50.00 |
| Hyperlite ® 1639 | 50.00 |
| DEOA (90 wt-% in Water) | 1.66 |
| Water added | 3.44 |
| Niax Silicone L-3555 | 1.00 |

| | | |
|---|---|---|
| DMEE | 0.40 | |
| Catalyst 2 | | 0.40 |

| | |
|---|---|
| TDI Scuranate T80 | 42.98 |

| | | |
|---|---|---|
| Exit time (s) | 50 | 50 |
| FTC, N | 862 | 844 |
| hot ILD, N | 174 | 195 |
| ILD, N | 451 | 553 |
| Weight [gram] | 365 | 364 |
| Density (kg/m³) | 40 | 40 |

Surprisingly, it was found that the PU foam prepared by adding 0.40 pbw. Cu(OAc)₂*H₂O to DMEE (Example 3) has higher hot ILD value (195 N). The Comparative Example 3 prepared by using 0.40 pbw. DMEE possesses a lower hot ILD value of 174 N. Moreover, significantly higher ILD value (553 N) was obtained for Example 3, whereas the Comparative Example 3 prepared by using DMEE alone possesses an ILD value of 451 N. The higher ILD value demonstrating, that the force required to deflect the foam pad to 50% of its original thickness is higher, indicates that the inventive catalyst 2 even at a lover concentration of 0.40 pbw composition provides beneficially better post-curing.

1. A composition comprising (A) at least one tertiary amino compound, and (B) at least one copper(II)-compound, selected from the group consisting of Cu(II)-carboxylates, hydrates and adducts with said tertiary amino compound (A) thereof, wherein said compositions comprise unbound tertiary amino compound (A).

2. The composition according to claim 1, wherein the weight ratio of the tertiary amine compound (A) to the Cu(II)-compound (B) is >2:1.

3. The composition according to claim 1, which form a homogenous liquid at room temperature (about 25° C.).

4. The composition according to claim 1, which form a homogeneous liquid after preparation and standing at room temperature (about 25° C.) for at least 14 days.

5. The composition according to claim 1, wherein the at least one tertiary amino compound (A) has at least one further functional group.

6. The composition according to claim 5, wherein the functional group is selected from hydroxyl (—OH), ether (—O—), amide, carbamate, primary, secondary or tertiary amino groups.

7. The composition according to claim 5, wherein the functional group is capable of coordinating the Cu(II)-ion.

8. The composition according to claim 1, wherein the copper(II)-compound (B) is selected from Cu(II)-carboxylates.

9. The composition according to claim 1, wherein the molar ratio of the total of the molar amount of the tertiary amino groups and the molar amount of the optional further functional groups in the tertiary amino compound to the molar amount of Cu(II) present in the composition (Σ (mol tert. amino groups+mol optional functional groups)/mol Cu(II)), is more than 4:1.

10. The composition according to claim 1, wherein the amount of the tertiary amino compound(s) (A) is such that the tertiary amino compound(s) (A) is capable to dissolve the copper(II)-compound(s) (B), to form a homogenous liquid at room temperature (about 25° C.).

11. The composition according to claim 1, wherein the molar ratio of the tertiary amino compound (A) to the copper(II)-compound (B) is >2.

12. The composition according to claim 1, wherein the copper(II)-compound (B) is copper(II)-acetate or hydrates thereof.

13. The composition according to claim 1, wherein the tertiary amino compounds (A) are selected from the group consisting of:
i. Tertiary amino compounds having at least one further amino group, selected from primary, secondary, and tertiary amino groups;
ii. Tertiary amino compounds having at least one hydroxyl group, wherein the number of carbon atoms connecting the nitrogen atom of the tertiary amino group and the oxygen atom of the hydroxyl group is at least 2 except 3; and
iii. Tertiary amino compounds having at least one ether group, wherein the number of carbon atoms connecting the nitrogen atom of the tertiary amino group and the oxygen atom of the ether group is at least 2.

14. The composition according to claim 1, wherein the tertiary amino compounds (A) are selected from aliphatic saturated tertiary amines which do not comprise any multiple bond.

15. The composition according to claim 1, wherein the tertiary amino compounds (A) are selected from the group consisting of: 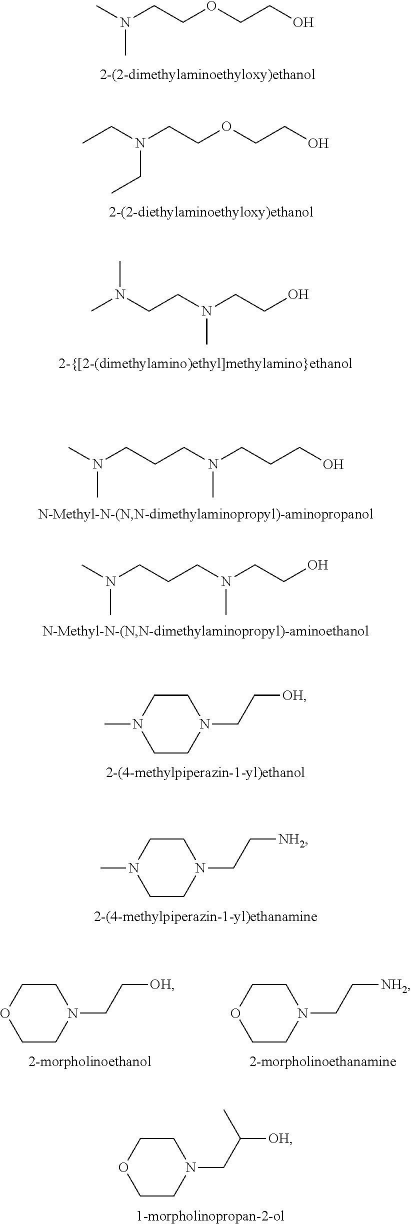 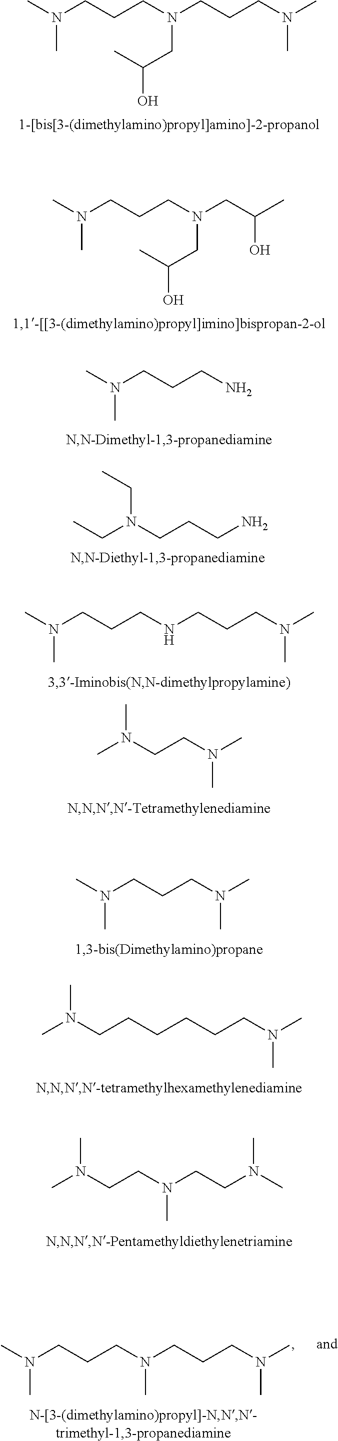 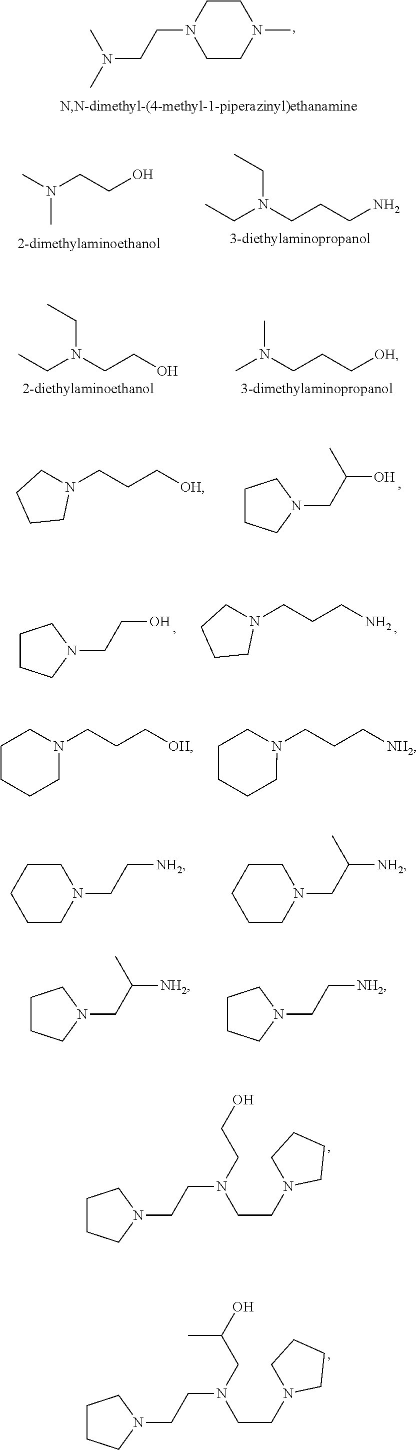 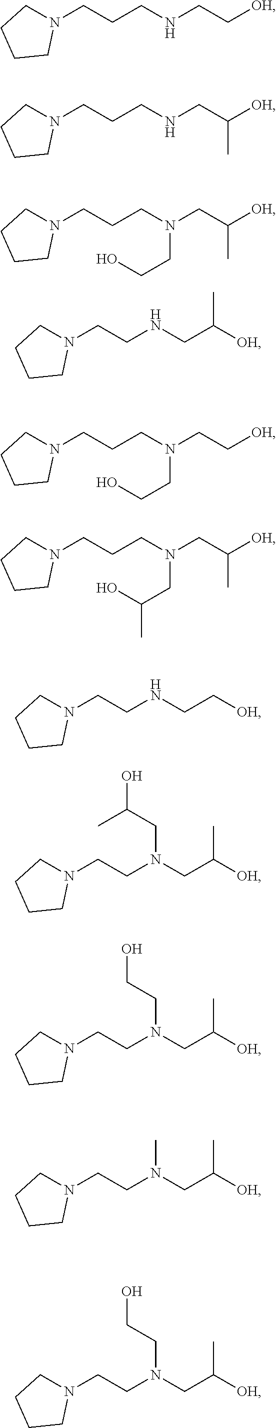 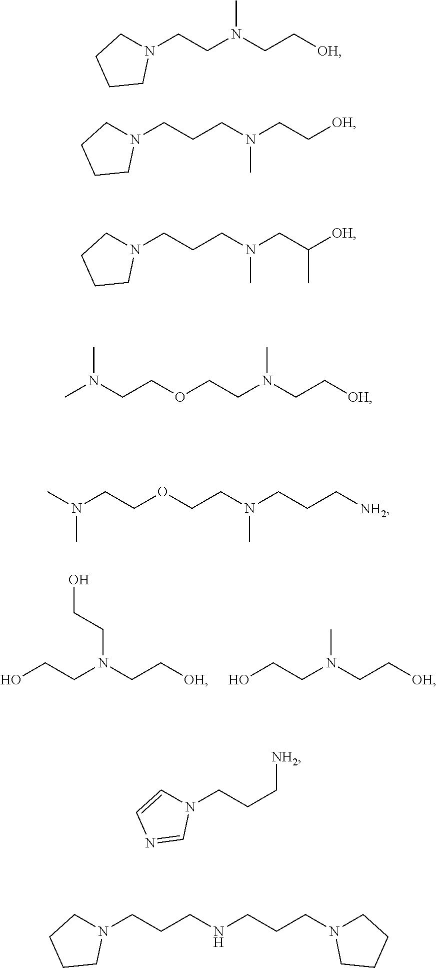
and mixtures thereof.

16. The composition according to claim 1 obtainable by mixing at least one tertiary amino compound (A), and at least one copper(II)-compound (B) selected from the group consisting of Cu(II)-carboxylates (B) and hydrates thereof, in an amount that said compositions comprise unbound tertiary amino compound (A).

17. The compositions according to claim 1, further comprising one or more auxiliary components (C).

18. The composition according to claim 17, wherein the auxiliary components (C) is selected from reactants and additives for polyurethanes formation and additives for polyurethanes.

19. The composition according to claim 18, wherein component (C) is selected from the group consisting of:
i. polyether polyols derived from the reaction of polyaromatic alcohols with alkylene oxides;
ii. polyether polyols derived from the reaction of ring-opening polymerization of tetrahydrofurane;
iii. polyether polyols derived from the reaction of ammonia and/or an amine with alkylene oxides;
iv. polyester polyols derived from the reaction of a polyfunctional initiator with a hydroxycarboxylic acid or lactone thereof;
v. polyester polyols derived from the reaction of a polyfunctional glycol with a polyfunctional acid;
vi. polyoxamate polyols derived from the reaction of an oxalate ester and a diamine directly in a polyether polyol;
vii. polyurea polyols derived from the reaction of a diisocyanate and a diamine directly in a polyether polyol;
viii. copolymer polyols;
ix. primary and secondary amine terminated polymers;
x. diluents;
xi. polyurethane additives;
xii. crosslinkers; and
xiii. further conventional catalysts for polyurethane formation and mixtures thereof.

20. The composition according to claim 1, comprising one or more diluents.

21. The composition according to claim 20, wherein the diluent is selected from isocyanate-reactive compounds or non-isocyanate-reactive compounds.

22. The composition according to claim 1, which do not comprise any further diluent except for water in an amount that does not lead to precipitates at room temperature (about 25° C.).

23. A process for the manufacture of the compositions according to claim 1, which comprises the step of mixing at least one tertiary amino compound (A), and at least one copper(II)-compound (B) selected from the group consisting of Cu(II)-carboxylates (B) and hydrates thereof, in an amount that said compositions comprise unbound tertiary amino compound, optionally in the presence of one or more auxiliary components (C).

24. The composition according to claim 1, comprising:
>50 to 98 parts by weight of the tertiary amino compound (A), and
2 to <50 parts by weight of the copper(II)-compound (B),
and based on 100 parts by weight of components (A) and (B):
0 to 2000 parts by weight one or more auxiliary components (C),

25. The composition according to claim 1, comprising:
66 to 95 mol-% of the at least one tertiary amino compound (A), and
5 to 34 mol-%, of the at least one copper(II)-compound (B),
wherein the total amount of components (A) and (B) adds up to 100 mol-%.

26. (canceled)

27. (canceled)

28. (canceled)

29. (canceled)

30. (canceled)

31. A catalyst composition comprising the composition according to claim 1.

32. A process for the manufacture of an isocyanate addition product comprising reacting an isocyanate compound with an isocyanate-reactive compound in the presence of the composition as defined in claim 1.

33. The process for the manufacture of an isocyanate addition product, according to claim 32, wherein the isocyanate is a polyisocyanate and the isocyanate-reactive compound is a polyol, and the process is for producing a polyurethane, in particular a polyurethane foam where water is used as blowing agent or co-blowing agent.

34. The process for the manufacture of an isocyanate addition product according to claim 32, wherein the isocyanate addition product is a polyurethane selected from cellular or non-cellular polyurethanes, and the process optionally comprises a blowing agent, such as water.

35. The process for the manufacture of an isocyanate addition product according to claim 32, wherein the process is for producing a polyurethane, and the process optionally comprises the addition of an auxiliary component (C), such as surfactants, fire retardants, chain extenders, cross-linking agents, adhesion promoters, anti-static additives, hydrolysis stabilizers, UV stabilizers, lubricants, anti-microbial agents, or a combination of two or more thereof.

36. The process for the manufacture of an isocyanate addition product according to claim 32, wherein the composition is present in an amount of about 0.005 wt-% to about 5 wt-% based on the total weight of the total composition including all components.

37. An isocyanate addition product forming a foam obtainable from the process of the manufacture of an isocyanate addition product of claim 1.

38. The isocyanate addition product forming a foam according to claim 37, selected from the group consisting of slabstock, molded foams, flexible foams, rigid foams, semi-rigid foams, spray foams, thermoformable foams, microcellular foams, footwear foams, open-cell foams, closed-cell foams, adhesives.
